(19) United States
(12) Patent Application Publication
(10) Pub. No.: US 2004/0061261 A1
(43) Pub. Date: Apr. 1, 2004

(54) Method of making a catheter balloon using a heated mandrel

(76) Inventors: Fernando Gonzalez, Campbell, CA (US); Arthur J. Wen, Sunnyvale, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/261,836

(22) Filed: Sep. 30, 2002

(51) Int. Cl. B29C 35/00

(52) U.S. Cl. 264/403; 264/486

(57) ABSTRACT

A method of making a catheter balloon or other tubular medical device or component, in which polymeric material is positioned on a mandrel, and the mandrel is heated by induction or conduction to heat the polymeric material. In one embodiment, the polymeric material is a tube heated on the mandrel to stabilize the polymeric tube. In another embodiment, a sheet of polymeric material is wrapped on the mandrel and heated thereon to fuse sections of the wrapped sheet together, to form a polymeric tube. After heating on the mandrel in accordance with the invention, the polymeric tube may be further processed before or after being removed from the mandrel, to complete the formation of the tubular medical device or medical device tubular component.

### BACKGROUND OF THE INVENTION

This invention generally relates to catheters, and particularly intravascular catheters for use in percutaneous transluminal coronary angioplasty (PTCA) or for the delivery of stents.

In percutaneous transluminal coronary angioplasty (PTCA) procedures a guiding catheter is advanced in the patient's vasculature until the distal tip of the guiding catheter is seated in the ostium of a desired coronary artery. A guidewire is first advanced out of the distal end of the guiding catheter into the patient's coronary artery until the distal end of the guidewire crosses a lesion to be dilated. A dilatation catheter, having an inflatable balloon on the distal portion thereof, is advanced into the patient's coronary anatomy over the previously introduced guidewire until the balloon of the dilatation catheter is properly positioned across the lesion. Once properly positioned, the dilatation balloon is inflated with inflation fluid one or more times to a predetermined size at relatively high pressures so that the stenosis is compressed against the arterial wall and the wall expanded to open up the vascular passageway. Generally, the inflated diameter of the balloon is approximately the same diameter as the native diameter of the body lumen being dilated so as to complete the dilatation but not overexpand the artery wall. After the balloon is finally deflated, blood flow resumes through the dilated artery and the dilatation catheter and the guidewire can be removed therefrom.

In such angioplasty procedures, there may be restenosis of the artery, i.e., reformation of the arterial blockage, which necessitates either another angioplasty procedure or some other method of repairing or strengthening the dilated area. To reduce the restenosis rate and strengthen the dilated area, physicians frequently implant a stent inside the artery at the site of the lesion. Stents may also be used to repair vessels having an intimal flap or dissection or to generally strengthen a weakened section of a vessel. Stents are usually delivered to a desired location within a coronary artery in a contracted condition on a balloon of a catheter which is similar in many respects to an angioplasty balloon catheter, and expanded to a larger diameter by expansion of the balloon. The balloon is deflated to remove the catheter and the stent left in place within the artery at the site of the dilated lesion. Stent covers commonly provided on an inner or an outer surface of the stent have been used in, for example, the treatment of pseudo-aneurysms and perforated arteries and to prevent prolapse of plaque, and generally comprise a cylindrical tube of synthetic or natural material. Similarly, vascular grafts comprising cylindrical tubes commonly made from tissue or synthetic materials such as polyester, expanded polytetrafluoroethylene, and DACRON, are configured to be implanted in vessels to strengthen or repair the vessel, or used in an anastomosis procedure to connect vessel segments together.

In the design of catheter balloons, characteristics such as strength, compliance, and profile of the balloon are carefully tailored depending on the desired use of the balloon catheter, and the balloon material and manufacturing procedure are chosen to provide the desired balloon characteristics. A variety of polymeric materials are conventionally used in catheter balloons. Use of polymeric materials such as PET that do not stretch appreciably consequently necessitates that the balloon is formed by blow molding, and the deflated balloon material is folded around the catheter shaft in the form of wings, prior to inflation in the patient's body lumen. However, it can be desirable to employ balloons, referred to as formed-in-place balloons, that are not folded prior to inflation, but which are instead expanded to the working diameter within the patient's body lumen from a generally cylindrical or tubular shape (i.e., essentially no wings) that conforms to the catheter shaft.

Catheter balloons formed of expanded polytetrafluoroethylene (ePTFE) expanded in place within the patient's body lumen without blow molding the ePTFE tubing have been disclosed. Prior disclosed methods of forming an ePTFE balloon involved wrapping a sheet of ePTFE on a mandrel and heating the wrapped sheet to fuse the layers of wrapped material together to form a tube. The resulting ePTFE tube may be subsequently heated in one or more additional heating steps during formation of the balloon. However, disclosed methods of forming an ePTFE tube can require substantial time, labor, and energy. It would be a significant advance to provide improved manufacturability of a polymeric tube for forming a balloon or other expandable medical device or component.

### SUMMARY OF THE INVENTION

This invention is directed to a method of making a catheter balloon or other tubular medical device or component, in which polymeric material is positioned on a mandrel, and the mandrel is heated by induction or conduction to heat the polymeric material. In one embodiment, the polymeric material is a tube heated on the mandrel to stabilize the polymeric tube. In another embodiment, a sheet of polymeric material is wrapped on the mandrel and heated thereon to fuse sections of the wrapped sheet together, to form a polymeric tube. After heating on the mandrel in accordance with the invention, the polymeric tube may be further processed before or after being removed from the mandrel, to complete the formation of the tubular medical device or medical device tubular component.

The mandrel heated by induction or conduction provides for improved heating of the polymeric material thereon. Specifically, the mandrel reaches a desired elevated temperature quickly, to quickly heat the polymeric material thereon. Moreover, with the polymeric material on a surface of the heated mandrel, the heat exchange between mandrel and the polymeric material is high, which consequently further increases the heating rate of the polymeric material. Additionally, the polymeric material on the heated mandrel is heated from an inner surface of the polymeric material, so that restraints or other members optionally provided on an outer surface of the polymeric material during heating will not insulate the polymeric material from the heat source. Consequently, the polymeric material is heated quickly and controllably. The optimized rate of heating provided by the method of the invention shortens manufacturing time.

In the embodiment in which the mandrel is heated by induction, the mandrel is heated by supplying current to an induction heat source, to thereby induce current in the mandrel. The induction heat source is preferably a coil defining a lumen, to maximize the current induced in the mandrel. However, a variety of suitable induction heat sources may be used. Commercially available induction heaters can be used. The power supplied to the coil is chosen to heat the mandrel to a desired temperature. Sensors such as IR sensors may be used to provide feedback control of the induction heating for controlling the temperature of the mandrel, as is conventionally known. Thus, during heating, the mandrel with the polymeric material thereon is positioned in the coil lumen, and the current in the coil induces current in the mandrel which resistively heats the mandrel to thereby heat the polymeric material thereon.

In the embodiment in which the mandrel is heated by conduction, the mandrel is connected to a heating element which heats the mandrel. In a presently preferred embodiment, one or more heating elements are in contact with an outer surface of a solid mandrel, to thereby heat the mandrel. However, a variety of suitable configuration can be used including a heating element positioned within a lumen of a hollow mandrel.

In one embodiment, the polymeric material on the mandrel is a tube, which is heated on the mandrel to stabilize the tube. Specifically, in one embodiment, the method generally comprises longitudinally stretching a polymeric tube on the mandrel to a stretched configuration, and heating the mandrel by induction or conduction to heat the polymeric tube in the stretched configuration. Typically, a restraint is applied to the polymeric tube in the stretched configuration prior to heating, to restrain the polymeric tube in the stretched configuration. The heated mandrel is cooled and the restraint restraining the polymeric tube in the stretched configuration is removed. During the heating of the polymeric tube in the stretched configuration, the polymeric tube is heated at a first elevated temperature and for a duration sufficient to stabilize the polymeric tube in the stretched configuration, so that the polymeric tube is in an at least partially stretched configuration after the restraint is removed. Moreover, in the embodiment in which the polymeric material is ePTFE, depending on the state of the ePTFE and the temperature used, sintering of the ePTFE can occur during the heating, as is conventionally known. In one embodiment, the method further includes, after the polymeric tube is heated in the longitudinally stretched configuration and the restraint restraining the polymeric tube in the stretched configuration is removed, longitudinally compressing the polymeric tube on the mandrel to a compressed configuration, and heating the mandrel by induction or conduction to heat the polymeric tube in the compressed configuration. Similarly, a restraint is typically applied to restrain the polymeric tube in the compressed configuration before heating. The polymeric tube is heated at a second elevated temperature and for a duration sufficient to stabilize the polymeric tube in the compressed configuration, so that the polymeric tube is in an at least partially compressed configuration after the restraint is removed. The heated mandrel is then cooled, to cool the heated polymeric tube thereon, and the polymeric tube is removed from the mandrel. The resulting polymeric tube can be used to form a layer of a variety of tubular medical devices or components such as a layer of a catheter balloon having at least one layer. The tube is heated in the longitudinally stretched and compressed configurations to provide a polymeric layer having the desired properties, such as the desired dimension, compliance, and dimensional stability (i.e., to minimize changes in length occurring during inflation of the balloon).

In another embodiment, the polymeric material on the mandrel is a sheet wrapped on the mandrel. The wrapped sheet of polymeric material is heated on the mandrel to fuse sections of the wrapped sheet together, to form a polymeric tube. The resulting polymeric tube can be further processed, for example by stretching, heating, compacting and heating as set forth above, to complete formation of a layer of a variety of tubular medical devices or components, such as a layer of a catheter balloon having at least one layer.

In a presently preferred embodiment, the tubular medical device or component formed according to the method of the invention is an inflatable balloon for a catheter. A balloon formed according to the method of the invention can be used on a variety of suitable balloon catheters including coronary and peripheral dilatation catheters, stent delivery catheters, drug delivery catheters and the like. Although discussed below primarily in terms of the embodiment in which the medical device component is an inflatable member such as a balloon for a catheter, it should be understood that other tubular expandable medical devices and components are included within the scope of the invention, including stent covers and vascular grafts.

In a presently preferred embodiment, the polymeric material heated on the mandrel in accordance with the invention comprises a polymer having a porous structure, which in one embodiment is selected from the group consisting of expanded polytetrafluoroethylene (ePTFE), an ultra high molecular weight polyolefin such as ultra high molecular weight polyethylene, polyethylene, polypropylene. In one embodiment, the porous material has a node and fibril microstructure. For example, ePTFE and ultra high molecular weight polyethylene (also referred to as “expanded ultrahigh molecular weight polyethylene”) typically have a node and fibril microstructure, and are not melt extrudable. The node and fibril microstructure, when present, is produced in the material using conventional methods. However, a variety of suitable polymeric materials can be used in the method of the invention including conventional catheter balloon materials which are melt extrudable. In one presently preferred embodiment, the polymeric material cannot be formed into a balloon by conventional balloon blow molding, and is formed into a balloon by heat fusing wrapped layers of the polymeric material together to form a tubular member. Porous materials such as ePTFE and ultrahigh molecular weight polyethylene typically require a nonporous second layer or liner when used to form an inflatable balloon. Thus, the tube of polymeric material forming a tubular medical device or component, which is heated on the mandrel in accordance with the invention, should be understood to include an embodiment where the tube forms a layer of a multilayered catheter balloon.

The method of the invention provides for improved heating of polymeric material during formation of a tubular medical device or component, due to the heating of the mandrel by induction or conduction. The mandrel and the polymeric material thereon are heated quickly and controllably. Additionally, the method of the invention provides ease of manufacturing of the polymeric tube by allowing the polymeric material to be heated directly on the mandrel without having to move the mandrel in and out of an oven, and minimizes the energy required for the heating of the polymeric material. These and other advantages of the invention will become more apparent from the following detailed description of the invention and the accompanying exemplary drawings.

### BRIEF DESCRIPTION OF THE DRAWINGS

FIG. 1 is an elevational view, partially in section, of a stent delivery balloon catheter embodying features of the invention.

FIG. 2 is a transverse cross sectional view of the balloon catheter shown in FIG. 1, taken along line 2-2.

FIG. 3 is a transverse cross sectional view of the balloon catheter shown in FIG. 1, taken along line 3-3.

FIGS. 4 and 5 illustrate an assembly of a tube of polymeric material on a mandrel, partially in section, during heating of the tube in a longitudinally stretched configuration and a longitudinally compressed configuration, respectively, to form a layer of the balloon of FIG. 1, in a method which embodies features of the invention, in which the mandrel is heated by induction.

FIG. 6 is a transverse cross sectional view of the assembly shown in FIG. 5, taken along line 6-6.

FIG. 7 illustrates an assembly of a wrapped sheet of polymeric material on a mandrel, partially in section, during heating of the wrapped tube to form a layer of the balloon of FIG. 1, in an alternative method which embodies features of the invention, in which the mandrel is heated by conduction.

### DETAILED DESCRIPTION OF THE INVENTION

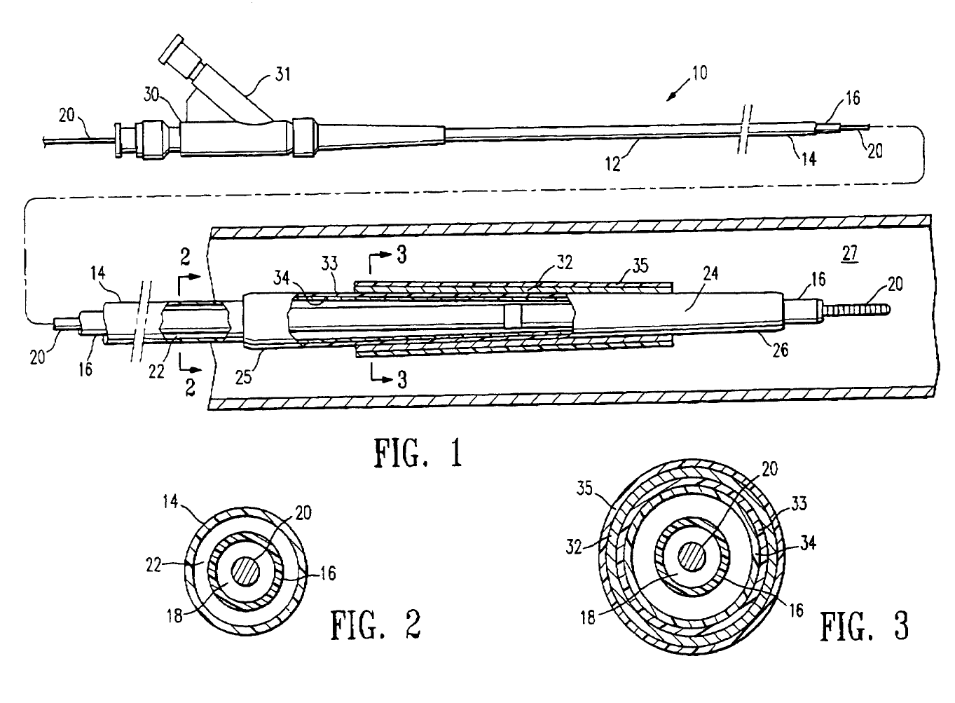

FIG. 1 illustrates an over-the-wire type stent delivery balloon catheter 10 embodying features of the invention. Catheter 10 generally comprises an elongated catheter shaft 12 having an outer tubular member 14 and an inner tubular member 16. Inner tubular member 16 defines a guidewire lumen 18 configured to slidingly receive a guidewire 20, and the coaxial relationship between outer tubular member 14 and inner tubular member 16 defines annular inflation lumen 22, as best illustrated in FIG. 2 showing a transverse cross section view of the distal end of the catheter of FIG. 1, taken along line 2-2. An inflatable balloon 24 disposed on a distal section of catheter shaft 12 has a proximal skirt section 25 sealingly secured to the distal end of outer tubular member 14 and a distal skirt section 26 sealingly secured to the distal end of inner tubular member 16, so that its interior is in fluid communication with inflation lumen 22. An adapter 30 at the proximal end of catheter shaft 12 is configured to provide access to guidewire lumen 18, and to direct inflation fluid through arm 31 into inflation lumen 22. FIG. 1 illustrates the balloon 24 prior to complete inflation, with an expandable stent 32, with a stent cover 35 thereon, mounted on a working length of the balloon. The distal end of catheter may be advanced to a desired region of a patient's body lumen 27 in a conventional manner, and balloon 24 inflated to expand stent 32, and the balloon deflated, leaving stent 32 implanted in the body lumen.

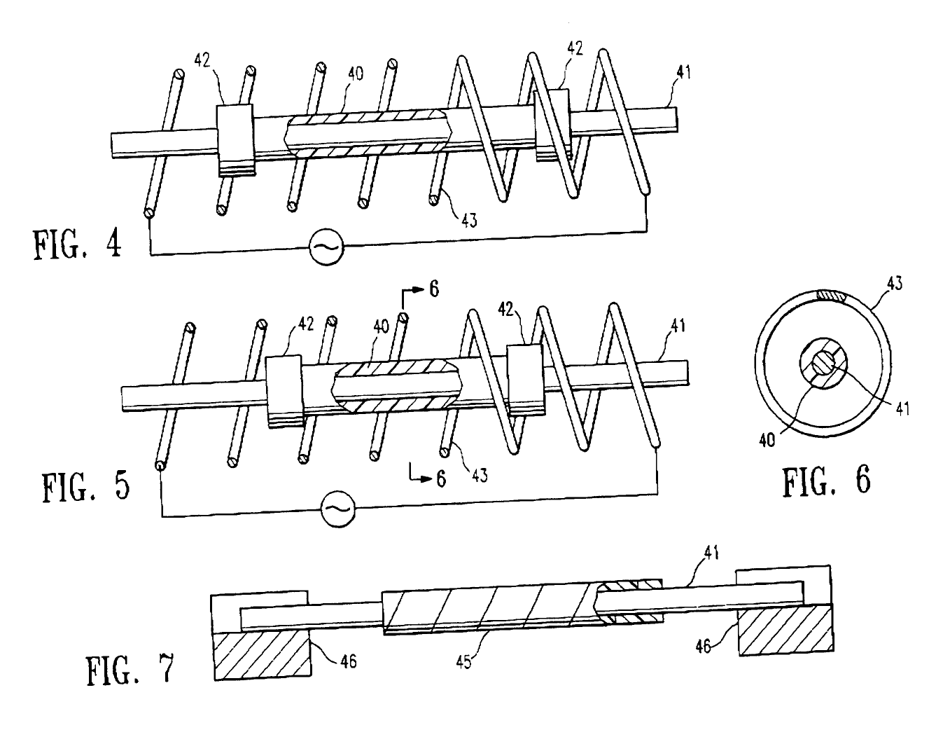

In the embodiment illustrated in FIG. 1, balloon 24 has a first layer 33 and a second layer 34. In a presently preferred embodiment, the balloon 24 first layer 33 comprises a porous polymeric material, and preferably a microporous polymeric material having a node and fibril microstructure, such as ePTFE. In the embodiment illustrated in FIG. 1, first layer 33 is formed of ePTFE, and the second layer 34 is formed of a polymeric material preferably different from the polymeric material of the first layer 33. Although discussed below in terms of one embodiment in which the first layer 33 is formed of ePTFE, it should be understood that the first layer may comprise other materials. The second layer 34 is preferably formed of an elastomeric material, including polyurethane elastomers, silicone rubbers, styrene-butadiene-styrene block copolymers, polyamide block copolymers, and the like. In a preferred embodiment, layer 34 is an inner layer relative to layer 33, although in other embodiments it may be an outer layer. Layer 34 formed of an elastomeric material limits or prevents leakage of inflation fluid through the microporous ePTFE to allow for inflation of the balloon 24, and expands elastically to facilitate deflation of the balloon 24 to a low profile deflated configuration. The elastomeric material forming layer 34 may consist of a separate layer which neither fills the pores nor disturbs the node and fibril structure of the ePTFE layer 33, or it may at least partially fill the pores of the ePTFE layer. The ePTFE layer 33 is formed according to a method which embodies features of the invention in which a mandrel is heated to heat polymeric material thereon. FIG. 4 illustrates an assembly of a polymeric tube 40 on a mandrel 41 during heating of the tube in a method which embodies features of the invention. The polymeric material of the tube 40 is ePTFE in the embodiment in which the tube forms ePTFE layer 33 of the balloon 24 of FIG. 1. The mandrel 41 comprises a metallic body which in the embodiment of FIG. 4 is a solid metal wire or rod. Although not illustrated, the mandrel 41 may be provided with a polymeric jacket on an outer surface of the metallic body, between the polymeric tube 40 and the metallic body of the mandrel 41.

FIG. 4 illustrates the tube 40 in a longitudinally stretched configuration on the mandrel 41. Restraints 42 on the polymeric tube restrain the polymeric tube 40 in the stretched configuration. In the embodiment of FIG. 4, the restraints 42 comprise collet-like blocks which clamp down around the outside of the tube 40, although a variety of suitable restraints may be used including clips, an outer film, jacket, or mold, and the like. The tube 40 is typically longitudinally stretched by about 200% to about 300%, preferably by about 200% to about 250% of the original length of the tube. For example, in one embodiment, the original length of the tube 40 is about 40 cm to about 80 cm, and the tube is longitudinally stretched to a length of about 80 cm to about 160 cm. The polymeric tube is generally longitudinally stretched by being placed around the mandrel 41 and pulled at either end to stretch it down on to the mandrel, although it can be longitudinally stretched using a variety of suitable methods.

The mandrel 41 is heated to heat the tube 40 in the longitudinally stretched configuration, to thereby stabilize the tube 40 in the stretched configuration. In the embodiment of FIG. 4, a metallic coil 43 heats the mandrel 41 by induction. The mandrel 41 is in the lumen of the coil 43, so that a current applied to the coil 43 induces current in the metallic body of the mandrel 41, to thereby heat the mandrel 41. Preferably, the current applied to the coil is an alternating current. However, the system can be modified as is conventionally known to allow for a direct current applied to the coil to induce current in the mandrel (i.e., by providing for relative movement between the coil and the mandrel). The metallic body of the mandrel 41 is preferably a magnetic stainless steel, including in one embodiment 440-stainless steel. However, a variety of suitable metals may be used to form the metallic body of the mandrel 41, thus affecting the induction of current in the mandrel. Generally, the mandrel 41 is heated by induction to an elevated temperature of about 200° C. to about 400° C. The mandrel 41 is generally heated at the elevated temperature for about 1 to about 30 minutes. The inductively heated mandrel 41 preferably reaches the elevated temperature in about 1 to about 3 seconds, and the polymeric tube 40 reaches the same elevated temperature as the heated mandrel 41 in about 3 to about 5 seconds. The operating specifications, such as power supplied to the coil 43, depend on the desired elevated temperature and the inductive heater characteristics. The polymeric tube 40 is preferably heated by the mandrel 41 in a single heat treatment, although it may alternatively be heated in multiple stages at one or more elevated temperatures which collectively heat stabilize the polymeric tube. The heat treatment stabilizes the polymeric tube in the stretched configuration, so that the polymeric tube is in an at least partially stretched configuration after the restraints are removed. Preferably, the unrestrained polymeric tube retains an at least partially stretched configuration after the heat stabilization, and specifically it has a stabilized stretched length which is about 200% to about 300% greater than the original pre-stretched length. Following the heat stabilization in the longitudinally stretched configuration, the mandrel 41 and polymeric tube 40 thereon are cooled to ambient temperature by turning off the current in the coil 43, and the tube 40 may be further processed or removed from the mandrel 41.

In a presently preferred embodiment, following the heat stabilization in the longitudinally stretched configuration, the polymeric tube 40 is longitudinally compressed and heated in the longitudinally compressed configuration. FIG. 5 illustrates the polymeric tube 40 on the mandrel 41 in a longitudinally compressed configuration. FIG. 6 is a transverse cross sectional view of the assembly shown in FIG. 5, taken along line 6-6. The tube 40 is typically longitudinally compressed on the mandrel 41 by being longitudinally pushed at either end. In the embodiments in which the tube 40 is formed of a porous polymeric material such as ePTFE, the longitudinal compression typically does not eliminate the porosity of the polymeric material, although it may reduce the porosity. The tube 40 is typically longitudinally compressed by about 20% to about 60% of the length of the tube 40 (i.e., the decrease in the length of the tube expressed as a percentage of the stabilized longitudinally stretched length of the tube just prior to the longitudinal compression). For example, in one embodiment, a tube 40 having a length of about 7 to about 9 cm is longitudinally compressed to a length of about 3 to about 4 cm. Similar to the embodiment of FIG. 4, the tube 40 is restrained with restraints 42 comprising blocks clamped down around the outside of the mandrel 41 to hold the tube 40 in the compressed configuration, and the compressed tube 40 is heated by inductively heating the mandrel 41. Generally, during the heat stabilization of the longitudinally compressed tube 40, the mandrel 41 is heated to an elevated temperature of about 200° C. to about 400° C., and for an ePTFE tube it is preferably heated to about 230° C. to about 350° C. The mandrel is generally heated at the elevated temperature for about 0.5 to about 30 minutes, and for an ePTFE tube 40 it is preferably heated for about 1 to about 30 minutes, to preferably heat the polymeric tube 40 to the same elevated temperature as the mandrel. The inductively heated mandrel 41 and the polymeric tube 40 preferably reach the elevated temperature in about 30 to about 60 seconds. The polymeric tube 40 is preferably heated by the mandrel 41 in a single heat treatment, although it may alternatively be heated in multiple stages at one or more elevated temperatures which collectively heat stabilize the polymeric tube.

The heat treatment stabilizes the polymeric tube 40 in the compressed configuration, so that the polymeric tube is in an at least partially compressed configuration after the restraints are removed. Preferably, the unrestrained polymeric tube retains an at least partially compressed configuration after the heat stabilization, and specifically it has a stabilized compressed length which is about 20% to about 60% greater than the original pre-compressed length. Following the heat stabilization in the longitudinally compressed configuration, the mandrel 41 and polymeric tube 40 thereon are cooled to ambient temperature, and the tube 40 removed from the mandrel 41. The completed polymeric layer 33 is typically then bonded to or otherwise combined with the elastomeric liner 34 to complete the balloon 24.

Although not illustrated, the mandrel 41 may alternatively be heated by conduction to heat stabilize the tube 40 in the longitudinally stretched or compressed configurations, as discussed in more detail below.

In the embodiments of FIGS. 4 and 5, the polymeric material heated on the mandrel has already been formed into a tube. In an alternative embodiment illustrated in FIG. 7, the polymeric material (e.g., ePTFE) on the mandrel 41 is a sheet 45 of polymeric material wrapped on the mandrel 41, and the mandrel 41 is heated to heat fuse the wrapped material to form a tube.

In the embodiment of FIG. 7, the sheet 45 is a long strip of polymeric material having longitudinal edges along the length of the strip which are longer than the width of the sheet 45, and the sheet 45 is spirally wrapped around mandrel 41 to form a tube. The sheet 45 is wrapped on the mandrel 41 so that the longitudinal edges of the sheet 45 are brought together in an abutting or overlapping relation. The sheet 45 of polymeric material is preferably wrapped along a length of the mandrel 41 to form one or more layers of wrapped material. In one embodiment, multiple layers of polymeric material are wrapped on the mandrel 41, by, for example, wrapping the sheet 45 down the length of the mandrel 41 to form a first layer and then back again over the first layer one or more times to form additional layers, which in one embodiment results in two to five layers, preferably about three layers of material. In the embodiment having multiple layers of the sheet 45 of polymeric material wrapped on the mandrel 41, the multiple layers are typically fused together during the heat fusion of the abutting or overlapping edges of the wrapped sheet 45 to form a tube.

In the embodiment illustrated in FIG. 7, the mandrel 41 is heated by conduction. Heating elements 46 in contact with the mandrel 41 heat the mandrel 41. FIG. 7 illustrates the heating elements 46 in cross section, and in the illustrated embodiment the heating elements 46 generally comprise metallic blocks with a channel configured to receive the mandrel 41 therein. The metallic blocks can be heated by a variety of suitable methods including resistive heaters. Generally, the mandrel 41 is heated to an elevated temperature of about 200° C. to about 400° C. The mandrel 41 is generally heated at the elevated temperature for about 1 to about 30 minutes, to preferably heat the wrapped sheet 45 of polymeric material to the same elevated temperature as the mandrel. The conductively heated mandrel 41 and wrapped sheet 45 of polymeric material preferably reach the elevated temperature in about 30 to about 60 seconds. The wrapped sheet 45 of polymeric material is preferably heated by the mandrel 41 in a single heat treatment, although it may alternatively be heated in multiple stages at one or more elevated temperatures which collectively heat fuse the wrapped sheet 45 of polymeric material together to form the polymeric tube. The resulting polymeric tube can be used to form a variety of tubular medical devices or components such as layer 33 of balloon 24 of the embodiment of FIG. 1. Although not illustrated, the mandrel 41 may alternatively be heated by induction as discussed in relation to the embodiment of FIGS. 4 and 5, to heat fuse the wrapped sheet 45 of polymeric material together to form the polymeric tube.

To the extent not previously discussed herein, the various catheter components may be formed and joined by conventional materials and methods. For example, the outer and inner tubular members 14, 16 can be formed by conventional techniques, such as by extruding and necking materials found useful in intravascular catheters such as polyethylene, polyvinyl chloride, polyesters, polyamides, polyimides, polyurethanes, and composite materials.

The length of the balloon catheter 10 is generally about 108 to about 200 centimeters, preferably about 137 to about 145 centimeters, and typically about 140 centimeters for PTCA. The outer tubular member 14 distal section has an outer diameter (OD) of about 0.028 to about 0.036 inch (0.70-0.91 mm), and an inner diameter (ID) of about 0.024 to about 0.035 inch (0.60-0.89 mm), and the outer tubular member 14 proximal section has an OD of about 0.017 to about 0.034 inch (0.43-0.87 mm), and an inner diameter (ID) of about 0.012 to about 0.022 inch (0.30-0.56 mm). The inner tubular member 16 has an OD of about 0.017 to about 0.026 inch (0.43-0.66 mm), and an ID of about 0.015 to about 0.018 inch (0.38-0.46 mm) depending on the diameter of the guidewire to be used with the catheter. The balloon 24 is has a length of about 14 mm to about 60 mm, and an inflated working diameter of about 2.5 mm to about 12 mm.

While the present invention has been described herein in terms of certain preferred embodiments, those skilled in the art will recognize that modifications and improvements may be made without departing from the scope of the invention. For example, although the embodiment illustrated in FIG. 1 is an over-the-wire stent delivery catheter, balloons of this invention may also be used with other types of intravascular catheters, such as rapid exchange balloon catheters. Rapid exchange catheters generally comprise a distal guidewire port in a distal end of the catheter, a proximal guidewire port in a distal shaft section distal of the proximal end of the shaft and typically spaced a substantial distance from the proximal end of the catheter, and a short guidewire lumen extending between the proximal and distal guidewire ports in the distal section of the catheter. While individual features of one embodiment of the invention may be discussed or shown in the drawings of the one embodiment and not in other embodiments, it should be apparent that individual features of one embodiment may be combined with one or more features of another embodiment or features from a plurality of embodiments.

What is claimed is:

1. A method of making a tubular medical device or component, comprising:
a) positioning a tube of polymeric material on a mandrel, and longitudinally stretching the polymeric tube on the mandrel to a stretched configuration, and applying a restraint to restrain the polymeric tube in the stretched configuration;
b) heating the mandrel by induction or conduction to heat the polymeric tube in the stretched configuration;
c) cooling the heated mandrel and polymeric tube thereon, and removing the restraint restraining the polymeric tube in the stretched configuration;
d) longitudinally compressing the polymeric tube on the mandrel to a compressed configuration, and applying a restraint to restrain the polymeric tube in the compressed configuration;
e) heating the mandrel by induction or conduction to heat the polymeric tube in the compressed configuration; and
f) cooling the heated mandrel and polymeric tube thereon, and removing the polymeric tube from the mandrel.

2. The method of claim 1 wherein the polymeric tube in the stretched configuration is heated at a first elevated temperature and for a duration sufficient to stabilize the polymeric tube in the stretched configuration, so that the polymeric tube is in an at least partially stretched configuration after c).

3. The method of claim 2 wherein the polymeric tube in the stretched configuration is heated at the first elevated temperature of about 200° C. to about 400° C. for about 1 to about 30 minutes.

4. The method of claim 3 wherein the polymeric tube reaches the first elevated temperature in about 30 to about 60 seconds.

5. The method of claim 1 wherein the polymeric tube in the compressed configuration is heated at a second elevated temperature and for a duration sufficient to stabilize the polymeric tube in the compressed configuration, so that the polymeric tube is in an at least partially compressed configuration after f).

6. The method of claim 5 wherein the polymeric tube in the compressed configuration is heated at the second elevated temperature of about 200° C. to about 400° C. for about 1 to about 30 minutes.

7. The method of claim 6 wherein the polymeric tube reaches the second elevated temperature in about 30 to about 60 seconds.

8. The method of claim 1 wherein the mandrel is heated by induction, and b) and d) comprise supplying alternating current to a coil, with the mandrel and the polymeric tube thereon in a lumen of the coil, to induce current in the mandrel.

9. The method of claim 8 wherein the mandrel is heated to an elevated temperature of about 200° C. to about 400° C., and the mandrel reaches the elevated temperature in about 30 to about 60 seconds.

10. The method of claim 1 wherein the mandrel is heated by conduction, and b) and d) comprise contacting the metallic mandrel with a heating element.

11. The method of claim 10 wherein the mandrel is heated to an elevated temperature of about 200° C. to about 400° C., and the mandrel reaches the elevated temperature in about 30 to about 60 seconds.

12. The method of claim 1 wherein the medical device tubular component is a balloon and the polymeric material is a porous material selected from the group consisting of expanded polytetrafluoroethylene, ultrahigh molecular weight polyethylene, polyethylene, and polypropylene, and b) comprises longitudinally stretching the polymeric material by about 200% to about 300%.

13. The method of claim 1 wherein the medical device tubular component is a balloon and the polymeric material is a porous material selected from the group consisting of expanded polytetrafluoroethylene, ultrahigh molecular weight polyethylene, polyethylene, and polypropylene, and d) comprises longitudinally compressing the polymeric material by about 5% to about 40%.

14. A method of making a tubular medical device or component, comprising:
a) positioning a tube of polymeric material on a mandrel, and applying a restraint to restrain the polymeric tube in a longitudinally compressed or stretched configuration on the mandrel;
b) heating the mandrel by induction or conduction to heat the restrained polymeric tube; and
c) cooling the heated mandrel and restrained polymeric tube thereon, and removing the restraint, and removing the polymeric tube from the mandrel.

15. A method of making a layer of a catheter balloon having at least one layer, comprising:
a) wrapping a sheet of polymeric material on a metallic mandrel;
b) heating the mandrel by induction or conduction to heat the wrapped sheet of polymeric material on the mandrel, to fuse sections of the wrapped sheet together to form a polymeric tube; and
c) removing the polymeric tube from the mandrel.

16. The method of claim 15 wherein the mandrel is heated by induction, and b) comprises supplying alternating current to a coil, with the mandrel and the polymeric tube thereon in a lumen of the coil, to induce current in the mandrel.

17. The method of claim 16 wherein the mandrel is heated to an elevated temperature of about 200° C. to about 400° C., and the mandrel reaches the elevated temperature in about 30 to about 60 seconds.

18. The method of claim 17 wherein the wrapped sheet of polymeric material is heated to the elevated temperature for about 0.5 to about 30 minutes.

19. The method of claim 15, including after b) and before c), longitudinally stretching the polymeric tube on the mandrel to a stretched configuration, applying a restraint to restrain the polymeric tube in the stretched configuration, heating the mandrel by induction or conduction to heat the polymeric tube in the stretched configuration, cooling the heated mandrel and polymeric tube thereon, and removing the restraint restraining the polymeric tube in the stretched configuration.

20. The method of claim 19, including after removing the restraint restraining the polymeric tube in the stretched configuration and before c), longitudinally compressing the polymeric tube on the mandrel to a compressed configuration, and applying a restraint to restrain the polymeric tube in the compressed configuration, s heating the mandrel by induction or conduction to heat the polymeric tube in the compressed configuration, and cooling the heated mandrel and polymeric tube thereon.

21. A method of making a polymeric tubular medical device or component, comprising:
a) positioning polymeric material on a mandrel;
b) inducing current in the mandrel and thereby heating the mandrel by induction, to heat the polymeric material on the mandrel; and
c) removing the polymeric material from the mandrel.
